(19) United States
(12) Patent Application Publication
(10) Pub. No.: US 2005/0079396 A1
(43) Pub. Date: Apr. 14, 2005

(54) Fuel cell unit and power control method

(76) Inventors: Akihiro Ozeki, Ome-shi (JP); Nobuo Shibuya, Hiratsuka-shi (JP)

Correspondence Address: Finnegan, Henderson, Farabow,;Garrett & Dunner, L.L.P., 1300 I Street, N.W., Washington, DC, 20005-3315, US

(21) Appl. No.: 10/944,873

(22) Filed: Sep. 21, 2004

(30) Foreign Application Priority Data
Sep. 30, 2003 (JP) 2003-342330

(51) Int. Cl. H01M 8/04; H01M 16/00

(52) U.S. Cl. 429/23; 429/34; 429/9; 429/13

(57) ABSTRACT

A fuel cell unit includes a fuel cell capable of generating electric power by chemical reaction, a pump which circulates fuel in the fuel cell, and a circuit configured to monitor an output voltage of the fuel cell and to control the pump to keep the output voltage at a predetermined level.

### CROSS-REFERENCE TO RELATED APPLICATIONS

This application is based upon and claims the benefit of priority from prior Japanese Patent Application No. 2003-342330, filed Sep. 30, 2003, the entire contents of which are incorporated herein by reference.

### BACKGROUND OF THE INVENTION

1. Field of the Invention

The present invention relates to a fuel cell unit having a direct methanol fuel cell and a power control method.

2. Description of the Related Art

Recently, portable electronic devices of various types such as a digital camera and a portable information terminal called a PDA (personal digital assistant) has been developed and widely used. The electronic device can be driven by a battery.

Moreover, recently, the issue of environment has received great attention and the development of environmentally friendly batteries has been increased. A direct methanol fuel cell (hereinafter referred to as DMFC) is well known as such a battery.

The DMFC generates electric energy by chemical reaction between oxygen and methanol provided as fuel. The DMFC has a structure in which an electrolyte is interposed between two electrodes made of porous metal or carbon. Since the DMFC produces no hazardous wastes, its practicality is strongly desired.

Some DMFCs include an auxiliary machine such as a liquid-sending/air-blowing pump in order to increase the output per unit area (volume). This type of DMFC generally has a secondary battery such as a lithium battery because the auxiliary machine needs to be driven when the DMFC starts up.

The DMFC is disclosed in, for example, K. Ikeda, “Outline of Fuel Cell,” Nippon Jitsugyo Publishing Co., Ltd., Aug. 20, 2001, pp. 216-217.

The foregoing auxiliary machine is a mechanism used for circulating oxygen and an aqueous solution of methanol serving as fuel and required for increasing power generating capacity per unit area.

However, the following problems occur. If the power of the auxiliary machine is too low, the DMFC does not increase in power. On the other hand, if the power of the auxiliary machine is too high, the DMFC increases in useless heat loss. It is thus desirable to adopt a technique of controlling the DMFC so as not to decrease in fuel use efficiency.

### BRIEF SUMMARY OF THE INVENTION

Embodiments of the present invention may provide a fuel cell unit capable of improving in fuel use efficiency and a power control method.

According to one aspect of the present invention, there is provided a fuel cell unit, comprising a fuel cell capable of generating electric power by chemical reaction; a pump which circulates fuel in the fuel cell; and a circuit configured to monitor an output voltage of the fuel cell and to control the pump to keep the output voltage at a predetermined level.

According to another aspect of the present invention, there is provided a power control method for a fuel cell unit including a fuel cell capable of generating electric power by chemical reaction and a pump which circulates fuel in the fuel cell, the method comprising monitoring an output voltage of the fuel cell; and controlling the pump to keep the output voltage at a predetermined level.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is an external view of an electronic system according to an embodiment of the present invention;

FIG. 2 is a schematic block diagram of a fuel cell unit;

FIG. 3 is a schematic block diagram of a fuel circulation mechanism of the fuel cell unit;

FIG. 4 is a schematic block diagram of an electronic device;

FIG. 5 is a block diagram of a configuration for power control of an auxiliary machine;

FIG. 6 is a graph of characteristics of cells of a DMFC cell stack;

FIG. 7 is a block diagram showing an example of the internal structure of a pump power supply;

FIG. 8 is a graph showing a relationship between a monitoring voltage and pump power;

FIG. 9 is a block diagram showing an example in which a DC/DC converter is applied to the configuration shown in FIG. 5; and

FIG. 10 is a graph illustrating power control by a two-stage monitoring voltage.

### DETAILED DESCRIPTION OF THE INVENTION

Embodiments of the present invention will be described below with reference to the drawings.

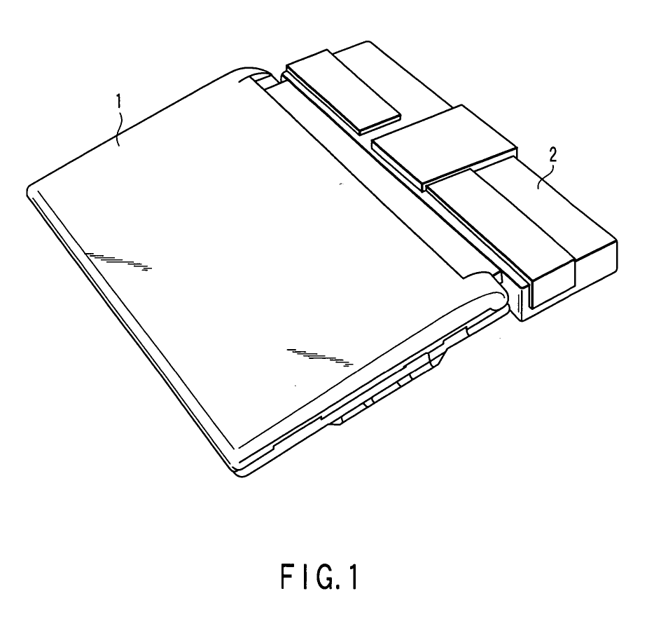

FIG. 1 is an external view of an electronic system according to an embodiment of the present invention.

Referring to FIG. 1, the electronic system includes an electronic device 1 and a fuel cell unit 2 that is detachable from the electronic device 1. The electronic device 1 is a notebook personal computer in which a top cover having an LCD (liquid crystal device) on its inner side is attached to the main unit by a hinge mechanism such that it can freely be opened and closed. The electronic device 1 can be operated by power supplied from the fuel cell unit 2. The fuel cell unit 2 includes a DMFC capable of generating power by chemical reaction and a repeatedly chargeable/dischargeable secondary battery.

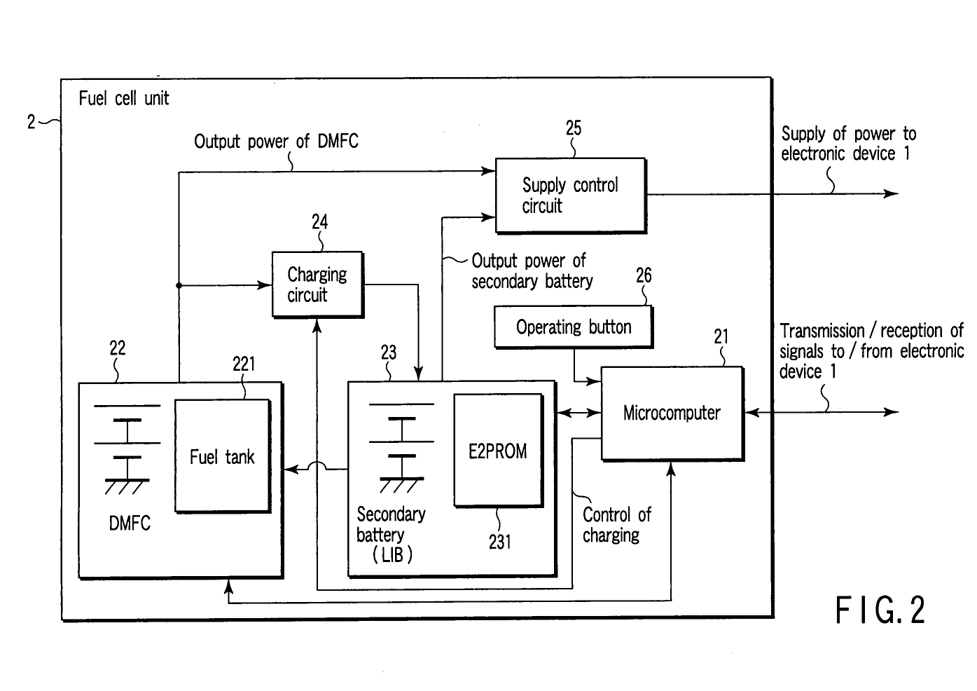

FIG. 2 is a schematic block diagram of the fuel cell unit 2.

Referring to FIG. 2, the fuel cell unit 2 includes a microcomputer 21, a DMFC 22, a secondary battery 23, a charging circuit 24, a supply control circuit 25 and an operating button 26.

The microcomputer 21 controls the entire operation of the fuel cell unit 2 and has a communication is function of transmitting/receiving signals to/from the electronic device 1. The microcomputer 21 controls the operations of the DMFC 22 and secondary battery 23 in response to an indicating signal from the electronic device 1 and performs a process corresponding to the depression of the operating button 26.

The DMFC 22 includes a detachable cartridge fuel tank 221 and outputs power that is generated by chemical reaction between air (oxygen) and methanol stored in the fuel tank 221. The chemical reaction occurs in a reaction section referred to as a cell stack or the like. In order to send the methanol and air into the cell stack with efficiency, the DMFC 22 has an auxiliary mechanism such as a pump. The DMFC 22 also has a mechanism to notify the microcomputer 21 of the attachment or detachment of the fuel tank 221, the amount of methanol remaining in the fuel tank 221, the operating status of the auxiliary mechanism, and the present amount of output power.

The secondary battery 23 stores power output from the DMFC 22 through the charging circuit 24, and outputs the power in response to the indication from the microcomputer 21. The secondary battery 23 has an EEPROM 231 that holds basic information indicative of discharge characteristics and the like. The EEPROM 231 can be accessed from the microcomputer 21. The secondary battery 23 has a mechanism to notify the microcomputer 21 of both the present output voltage level and the present output current value. The microcomputer 21 computes the amount of power remaining in the secondary battery 23 based on both the basic information read out of the EEPROM 231 and the output voltage and current values indicated by the secondary battery 23, and notifies the electronic device 1 of the computed amount. Assume here that the secondary battery 23 is a lithium battery (LIB).

The charging circuit 24 charges the secondary battery 23 with power output from the DMFC 22. The microcomputer 21 controls whether the secondary battery 23 is charged or not.

The supply control circuit 25 outputs the power of the DMFC 22 and secondary battery 23 to the outside according to the circumstances.

The operating button 26 is a dedicated button to give an instruction to stop the entire operation of the DMFC 22 or the fuel cell unit 2. The same function as that of the operating button 26 can be fulfilled by a button presented by the application on the LCD screen of the electronic device 1 or by depressing a power supply button of the electronic device 1 for a long time (depressing it longer than a given period of time).

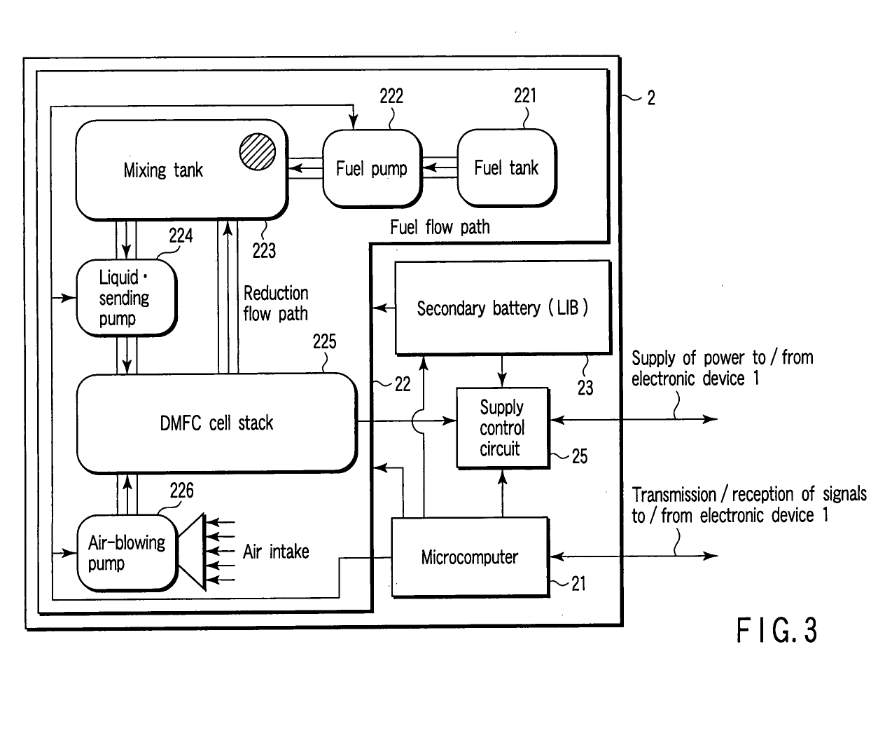

FIG. 3 is a block diagram of a fuel circulation mechanism of the fuel cell unit 2. The components that correspond to those of FIG. 2 are denoted by the same reference numerals.

Referring to FIG. 3, the DMFC 22 includes a fuel tank 221, a fuel pump 222, a mixing tank 223, a liquid-sending pump 224, a DMFC cell stack 225 and an air-blowing pump 226.

The methanol in the fuel tank 221 is supplied to the mixing tank 223 by the fuel pump 222 and diluted. The diluted methanol is sent into the DMFC cell stack 225 by the liquid-sending pump 224. Air is sent into the DMFC cell stack 225 by the air-blowing pump 226, and an aqueous solution of the diluted methanol reacts to oxygen in the air to generate power.

The foregoing microcomputer 21 performs control to drive an auxiliary machine such as the fuel pump 222, liquid-sending pump 224, air-blowing pump 226 and fan by the power of the secondary battery 23 in response to a startup indicating signal transmitted from the electronic device 1. The microcomputer 21 controls the supply control circuit 25 such that the electronic device 1 is supplied with power from the DMFC cell stack 225 or the secondary battery 23. The micro-computer 21 also performs control to charge the secondary battery 23 before the DMFC 22 stops in response to a stop indicating signal sent from the electronic device 1.

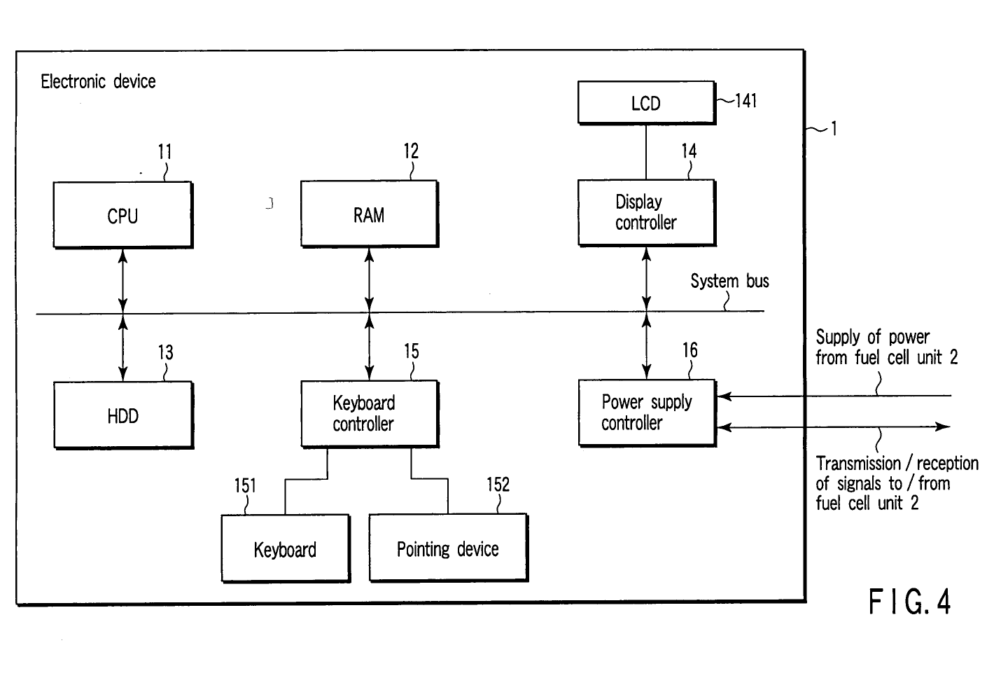

FIG. 4 is a schematic block diagram of the electronic device 1.

Referring to FIG. 4, the electronic device 1 includes a CPU 11, a RAM (main memory) 12, an HDD 13, a display controller 14, a keyboard controller 15 and a power supply controller 16. These are connected to a system bus.

The CPU 11 controls the entire operation of the electronic device 1 and executes various programs stored in the RAM 12. The RAM 12 is a memory device serving as a main memory of the electronic device 1 to store various programs to be executed by the CPU 11 and various items of data to be used for the programs. The HDD 13 is a memory device serving as an external memory of the electronic device 1 and an auxiliary device of the RAM 12 to store various programs and a large amount of data.

The display controller 14 controls the output side of a user interface in the electronic device 1 and displays image data created by the CPU 11 on an LCD 141. The keyboard controller 15 controls the input side of the user interface in the electronic device 1. The controller 15 converts the operations of a keyboard 151 and a pointing device 152 into numbers and supplies them to the CPU 11 via a register included therein.

The power supply controller 16 controls the supply of power to the respective components of the electronic device 1. The controller 16 has a power-receiving function of receiving power from the fuel cell unit 2 and a communication function of transmitting/receiving signals to/from the fuel cell unit 2. It is the microcomputer 21 in the fuel cell unit 2 shown in FIGS. 2 and 3 that transmits/receives signals to/from the power supply controller 16.

(Configuration for Power Control of Auxiliary Machine)

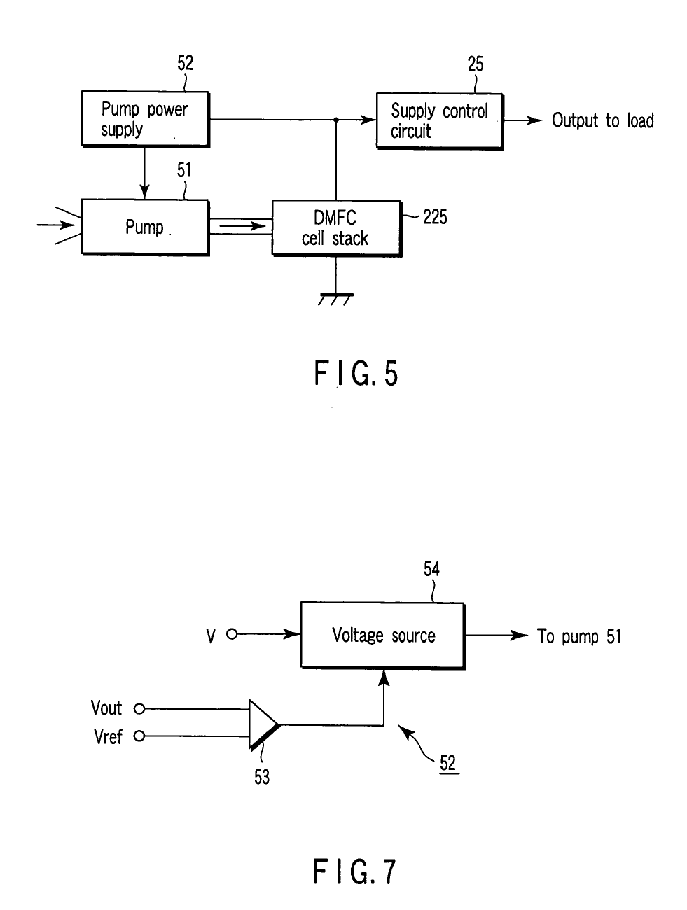

A configuration for power control of the auxiliary machine will be described with reference to FIG. 5.

Assume here that the auxiliary machine is represented as a pump 51 from the viewpoint of easy understanding. The pump 51 includes the fuel pump 222, liquid-sending pump 224 and air-blowing pump 226, which are described above with reference to FIG. 3.

A pump power supply (auxiliary power supply circuit) 52 applies electric power to the pump 51. The pump power supply 52 has a function of monitoring an output voltage of the DMFC cell stack 225 (or a unit cell) and controlling output pump power of the pump 51 to keep the output voltage at a predetermined level.

Both the DMFC cell stack 225 and supply control circuit 25 have already been described above.

(Power Control of Auxiliary Machine)

Following is an explanation of a power control method of the auxiliary machine.

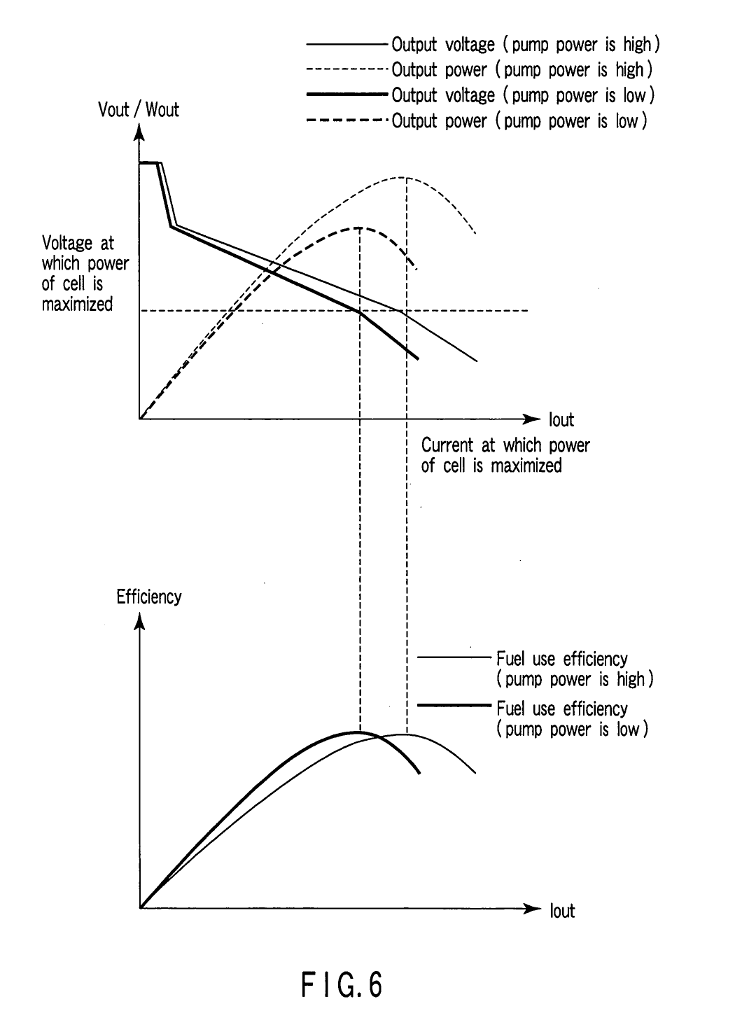

In general, the characteristics of cells of a DMFC cell stack using an auxiliary machine vary with the output power (or energy) of the auxiliary machine as shown in FIG. 6 (i.e., vary with the output pump power of the pump). This is because the amount of fuel (aqueous solution of methanol and oxygen) supplied to the DMFC varies. As the characteristics of the DMFC, when a load current is drawn out, electric power is maximized at a certain current value. When a larger load current is drawn out, the voltage of the cell suddenly drops and the supplied electric power lowers. The fuel use efficiency of the DMFC is usually maximized when the supplied electric power is maximized. Then, the amount of generated heat that does not contribute to electric power generation increases. In other words, excessive larger supply of fuel causes useless heat from the electric power generating cell and results in deterioration of fuel use efficiency.

In the present embodiment, the pump power supply 52 varies the pump power of the pump 51 according to the load to improve the fuel use efficiency. The pump power control of the pump 51 can be achieved by monitoring the output voltage of the DMFC cell stack 225. If the pump 51 varies in pump power, the DMFC cell stack 225 varies in output current Iout and output power Wout as shown in FIG. 6. When the output power Wout is maximized, the output voltage Vout of the DMFC cell stack 225 is almost uniform as shown in FIG. 6 even though the pump power of the pump 51 varies. If, therefore, the pump power of the pump 51 is controlled such that the output voltage Vout becomes constant, the DMFC cell stack 225 can always be operated at the highest fuel use rate.

(Determination of Monitoring Voltage)

There now follows an explanation of a method of determining a monitoring voltage of the DMFC cell stack 225 (i.e., a level of output voltage Vout to be controlled uniformly).

As is seen from FIG. 6, when the output current Iout exceeds the maximum value of the output power Wout, the output power Wout lowers due to a sudden drop in voltage. If the DMFC cell stack operates continuously at a high load, there occurs a phenomenon in which a larger amount of current will be drawn from the DMFC cell stack. It is likely that the electric power generating cell will become abnormal and be destroyed. The DMFC cell stack therefore needs to be used within a range where the output current Iout does not exceed a current value corresponding to the maximum value of the output power Wout. In other words, the safety of the DMFC cell stack can be secured by stably operating the DMFC cell stack at a voltage that is slightly higher than a voltage at which the supply of electric power is maximized.

The monitoring voltage depends on variations among cell stacks and precision of a circuit which executes voltage monitoring. For example, the monitoring voltage is determined under the following conditions:
The voltage Vmax at which a unit cell supplies a largest amount of electric power is 0.4 V;
The number Xs of cells used in stack is 20;
Variation Vts in voltage among cells is 0.01 V;
Every cell should not exceed 0.4 V; and
The voltage read precision Vtch on the circuit side is ±0.1 V.

Normally, the following is a value at which a largest amount of electric power is supplied: Vmax×Xs=0.4×20=8.0 V. In view of variations in voltage of cells, however, the voltage is maximized when the voltage of only one of the cells is low and its level is 0.4+0.41×19=8.19 V. Moreover, the level becomes 8.19+0.1=8.29 V due to the influence of the voltage read precision Vtch on the circuit side. That is, the following is a monitoring voltage for using the DMFC cell stack safely:
Vs=Vmax×Xs+Vts×(Xs−1)+Vtch
(Internal Structure of Pump Power Supply)

FIG. 7 shows an example of the internal structure of the pump power supply 52.

The pump power supply 52 includes a comparator 53 and a voltage source 54. The comparator 53 receives both a reference level Vref that is a preset monitoring voltage and an output voltage Vout of the DMFC cell stack 225 to be monitored and supplies the voltage source 54 with a control signal corresponding to a difference between them. In response to the control signal supplied from the comparator 53, the voltage source 54 generates a voltage necessary for the pump 51 from the DMFC cell stack 225 and outputs it.

(Relationship Between Monitoring Voltage and Power of Pump)

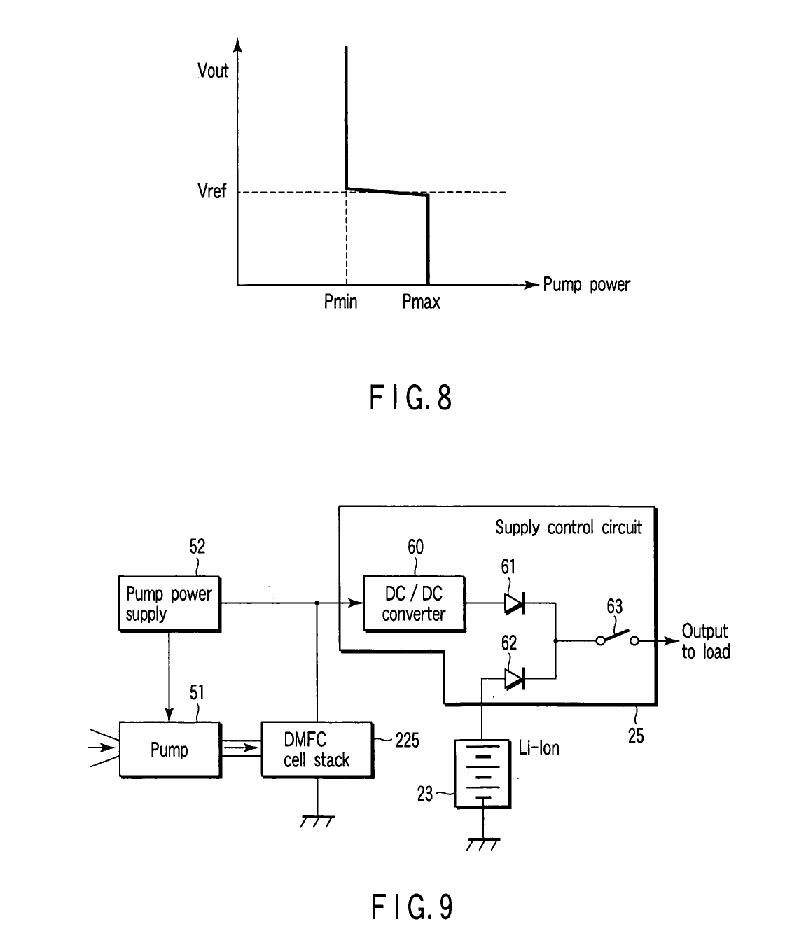

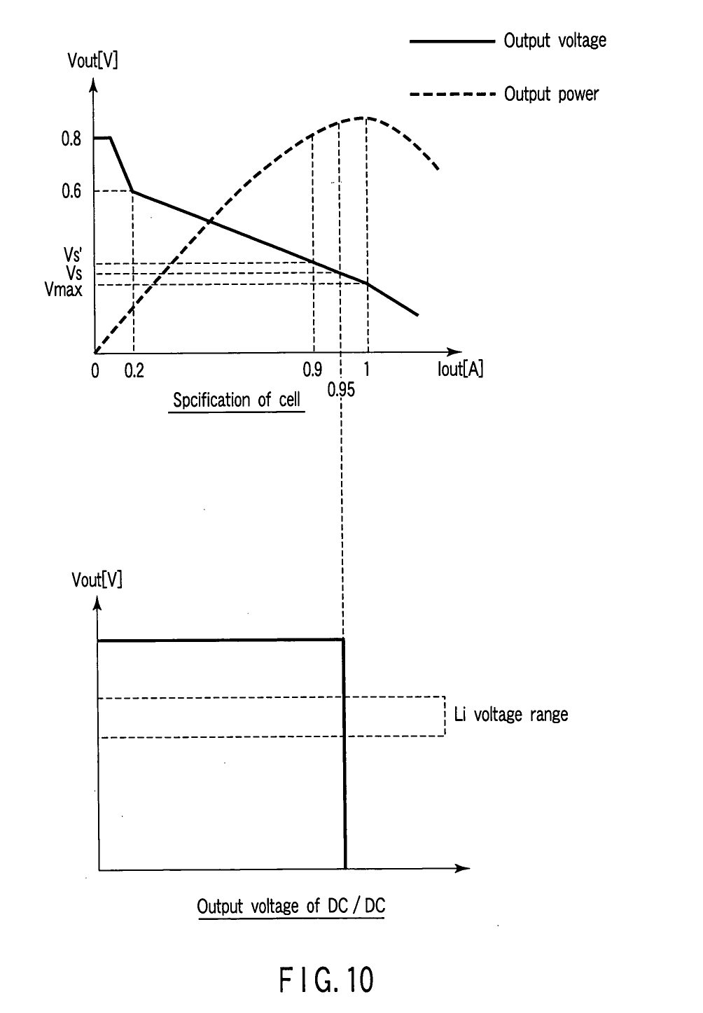

FIG. 8 shows a relationship between a monitoring voltage and pump power of the pump.

The pump power supply 52 controls the pump 51 to make the pump power of the pump 51 equal to the minimum value Pmin if the output voltage Vout of the DMFC cell stack 225 is higher than a reference voltage Vref corresponding to the monitoring voltage. On the other hand, the pump power supply 52 controls the pump 51 to make the pump power of the pump 51 equal to the maximum value Pmax if the output voltage Vout of the DMFC cell stack 225 is lower than the reference voltage Vref.

(Combination with DC/DC Converter)

An example in which a DC/DC converter is applied to the configuration shown in FIG. 5 will be described with reference to FIG. 9. As for the same components as those in FIG. 5, their detailed descriptions are omitted.

Referring to FIG. 9, the supply control circuit 25 includes a DC/DC converter (e.g., a boosting DC/DC converter) 60, two diodes (rectifiers) 61 and 62 and a switch 63.

The DC/DC converter 60 includes a booster circuit and DC/DC-converts electric power output from the DMFC cell stack 225 and then outputs the converted electric power. The DC/DC converter 60 has the following characteristics. The converter 60 monitors the output voltage Vout of a unit cell (or the stack itself) in the DMFC cell stack 225. When the output voltage Vout falls below the above reference voltage Vref (=Vs′ that is a first level) and becomes equal to or lower than a predetermined level Vs (that is a second level), the output voltage of the DC/DC converter 60 drops. Assume in this case that the predetermined level Vs is slightly higher than the voltage level Vmax corresponding to the peak value of the output power Wout of the DMFC cell stack 225. When the output voltage Vout becomes equal to or lower than the predetermined level Vs, the DC/DC converter 60 generates a voltage that drops as the output current increases. Then, the DC/DC converter 60 outputs a fixed electric power irrespective of the value of the output current.

The diodes 61 and 62 are combined into a diode OR circuit. The diode OR circuit selectively acquires electric power according to the load of a feeding destination from both the electric power output from the DC/DC converter 60 and that output from the secondary battery (LIB) 23 and outputs the electric power to the load.

The switch 63 is controlled by, for example, the microcomputer 21 (shown in FIGS. 2 and 3) described above to selectively supply and stop electric power to a load device (i.e., electronic device 1).

A DMFC cell stack is an electric power generator and its volume (size) will increase as its power supply capacity does. It is thus thought that both the DMFC cell stack 225 and secondary battery 23 are used as shown in FIG. 9. In this case, the electric power supplied from the DMFC cell stack 225 is set to about an average power required by the load device (i.e., electronic device 1), and electric power exceeding the average power is supplied from the secondary battery. However, it is desirable to use the DMFC cell stack 225 as effectively as possible and thus the DC/DC converter 60 having a constant-power characteristic is combined with the diode OR circuit. A configuration to control the pump power of the auxiliary machine is also combined with the combination of the DC/DC converter 50 and the diode OR circuit. Accordingly, a more efficient system can be achieved.

More specifically, the pump power supply 52 performs control to make the output voltage Vout of the DMFC cell stack 225 equal to Vs′ (Vs+α). If the output voltage Vout falls below the monitoring voltage Vs, the DC/DC converter 60 performs control to output a constant electric power. Since the pump power of the auxiliary machine is limited, the voltage may fall below Vs′; however, the output power Wout does not reach the peak value. If the output voltage Vout falls below Vs' and reaches Vs, a constant-power circuit of the DC/DC converter 60 keeps supplied electric power constant. In order to determine Vs′, the following need to be taken into consideration:
Voltage monitoring precision Vtcw of the constant-power circuit (e.g., 0.1 V); and
Voltage drop Vd due to a response delay of an auxiliary machine control circuit (e.g., 0.5 V).

Thus, Vs′ is expressed by the following equation:

Vs′ is thus expressed by:
Vs′=Vs+Vtcw+Vd (e.g., 8.29+0.1+0.5=8.89 V).

Since the output voltage Vout of the DMFC cell stack whose output power Wout is maximized at voltage Vmax is controlled using a two types of monitoring voltages that are higher than Vmax, a stable, efficient system can be achieved.

As described above in detail, the embodiment of the present invention can improve the fuel use efficiency of the fuel cell unit.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A fuel cell unit, comprising:
a fuel cell capable of generating electric power by chemical reaction;
a pump which circulates fuel in the fuel cell; and
a circuit configured to monitor an output voltage of the fuel cell and to control the pump to keep the output voltage at a predetermined level.

2. The fuel cell unit according to claim 1, wherein the predetermined level is higher than a voltage level corresponding to a peak value of the electric power generated by the fuel cell.

3. A fuel cell unit, comprising:
a fuel cell capable of generating electric power by chemical reaction;
a first circuit which DC/DC-converts electric power output from the fuel cell, outputs converted electric power, monitors an output voltage of the fuel cell, and drops a voltage of the converted electric power when the output voltage of the fuel cell falls below the first level and reaches a second level;
a pump which circulates fuel in the fuel cell; and
a second circuit configured to control pump power to keep the output voltage at a first level based on a monitored output voltage of the fuel cell.

4. The fuel cell unit according to claim 3, further comprising:
a battery which is repeatedly chargeable and dischargeable; and
a third circuit which selectively acquires electric power according to a load from both the electric power output from the first circuit and electric power output from the battery.

5. The fuel cell unit according to claim 3, wherein the first level and the second level are each higher than a voltage level corresponding to a peak value of the electric power generated by the fuel cell.

6. The fuel cell unit according to claim 5, wherein the first circuit outputs a constant electric power irrespective of a value of an output current when the output voltage of the fuel cell becomes equal to or lower than the second level.

7. A power control method for a fuel cell unit including a fuel cell capable of generating electric power by chemical reaction and a pump which circulates fuel in the fuel cell, the method comprising:
monitoring an output voltage of the fuel cell; and
controlling the pump to keep the output voltage at a predetermined level.

8. The power control method according to claim 7, wherein the predetermined level is higher than a voltage level corresponding to a peak value of the electric power generated by the fuel cell.

9. A power control method including a fuel cell capable of generating electric power by chemical reaction, a circuit which DC/DC-converts electric power output from the fuel cell and outputs converted electric power, and a pump which circulates fuel in the fuel cell, the method comprising:
controlling pump power to keep the output voltage at a first level based on a monitored output voltage of the fuel cell; and
monitoring an output voltage of the fuel cell and dropping a voltage of the converted electric power when the output voltage of the fuel cell falls below the first level and reaches a second level.

10. The power control method according to claim 9, further comprising:
selectively acquiring electric power according to a load from both the electric power output from the circuit and electric power output from a battery which is repeatedly chargeable and dischargeable.

11. The power control method according to claim 9, wherein the first level and the second level are each higher than a voltage level corresponding to a peak value of the electric power generated by the fuel cell.

12. The power control method according to claim 11, further comprising outputting a constant electric power from the circuit irrespective of a value of an output current when the output voltage of the fuel cell becomes equal to or lower than the second level.
